(19) United States
(12) Patent Application Publication
(10) Pub. No.: US 2017/0286826 A1
(43) Pub. Date: Oct. 5, 2017

(54) REAL-TIME DEEP LEARNING FOR DANGER PREDICTION USING HETEROGENEOUS TIME-SERIES SENSOR DATA

(71) Applicant: NEC Laboratories America, Inc., Princeton, NJ (US)

(72) Inventors: Renqiang Min, Princeton, NJ (US); Dongjin Song, Plainsboro, NJ (US)

(21) Appl. No.: 15/375,408

(22) Filed: Dec. 12, 2016

Related U.S. Application Data
(60) Provisional application No. 62/315,094, filed on Mar. 30, 2016.

(51) Int. Cl. G06N 3/04; G05D 1/00; G06N 3/08

(52) U.S. Cl. CPC G06N 3/0472; G06N 3/08; G05D 1/0088

(57) ABSTRACT

A computer-implemented method and a system are provided for, in turn, providing driver assistance for a vehicle. The method includes forming, by a processor, a deep High-Order Long Short-Term Memory (HOLSTM)-based model by applying, to a HOLSTM, high-order interactions captured between global pattern distribution probabilities and local feature representations of an input sensor signal vector at each of a plurality of time steps. The input sensor signal vector is formed from multiple time series. Each of the multiple time series corresponds to a different one of a plurality of driving related sensors. The method further includes generating, by the processor, one or more predictions of impending dangerous conditions related to driving the vehicle based on the deep HOLSTM-based model. The method also includes informing, by an operator-perceptable warning device, an operator of the vehicle of the one or more predictions of impending dangerous conditions.

### RELATED APPLICATION INFORMATION

This application claims priority to U.S. Provisional Pat. App. Ser. No. 62/315,094 filed on Mar. 30, 2016, incorporated herein by reference in its entirety.

### BACKGROUND

### Technical Field

The present invention relates to data processing and more particularly to real-time deep learning for danger prediction using heterogeneous time-series sensor data.

### Description of the Related Art

With the advancement of sensing and computing technology, smart vehicles have been made and are becoming more popular as commercial products. Advanced commercial vehicles with on-board cameras and sensors can even drive autonomously in some constrained traffic environments. However, making such autonomous smart vehicles is subject to many government regulations and is also highly expensive. To make affordable smart vehicles widely sold as standard automobiles, many auto manufactures are trying to design on-board sensing systems capable of understanding a surrounding driving environment and generating immediate danger alerts in real-time.

Thus, there is a need for a real-time system for danger prediction for vehicles.

### SUMMARY

According to an aspect of the present invention, a computer-implemented method is provided for, in turn, providing driver assistance for a vehicle. The method includes forming, by a processor, a deep High-Order Long Short-Term Memory (HOLSTM)-based model by applying, to a HOLSTM, high-order interactions captured between global pattern distribution probabilities and local feature representations of an input sensor signal vector at each of a plurality of time steps. The input sensor signal vector is formed from multiple time series. Each of the multiple time series corresponds to a different one of a plurality of driving related sensors. The method further includes generating, by the processor, one or more predictions of impending dangerous conditions related to driving the vehicle based on the deep HOLSTM-based model. The method also includes informing, by an operator-perceptable warning device, an operator of the vehicle of the one or more predictions of impending dangerous conditions.

According to another aspect of the present invention, a computer program product is provided for, in turn, providing driver assistance for a vehicle. The computer program product includes a non-transitory computer readable storage medium having program instructions embodied therewith. The program instructions are executable by a computer to cause the computer to perform a method. The method includes forming, by a processor, a deep High-Order Long Short-Term Memory (HOLSTM)-based model by applying, to a HOLSTM, high-order interactions captured between global pattern distribution probabilities and local feature representations of an input sensor signal vector at each of a plurality of time steps. The input sensor signal vector is formed from multiple time series. Each of the multiple time series corresponds to a different one of a plurality of driving related sensors. The method further includes generating, by the processor, one or more predictions of impending dangerous conditions related to driving the vehicle based on the deep HOLSTM-based model. The method also includes informing, by an operator-perceptable warning device, an operator of the vehicle of the one or more predictions of impending dangerous conditions.

According to yet another aspect of the present invention, a system is provided for, in turn, providing driver assistance for a vehicle. The system includes a processor. The processor is configured to form a deep High-Order Long Short-Term Memory (HOLSTM)-based model by applying, to a HOLSTM, high-order interactions captured between global pattern distribution probabilities and local feature representations of an input sensor signal vector at each of a plurality of time steps. The input sensor signal vector is formed from multiple time series. Each of the multiple time series corresponds to a different one of a plurality of driving related sensors. The processor is further configured to generate one or more predictions of impending dangerous conditions related to driving the vehicle based on the deep HOLSTM-based model. The system also includes an operator-perceptable warning device configured to inform an operator of the vehicle of the one or more predictions of impending dangerous conditions.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 shows a block diagram of an exemplary processing system to which the invention principles may be applied, in accordance with an embodiment of the present invention;

FIG. 2 shows a block diagram of an exemplary driving assistance system, in accordance with an embodiment of the present invention;

FIG. 3 shows a flow diagram of an exemplary method for driving assistance, in accordance with an embodiment of the present invention;

FIG. 4 shows a block diagram of an exemplary Deep High-Order Long Short-Term Memory (DHOLSTM), in accordance with an embodiment of the present invention;

FIG. 5 shows a block/flow diagram of an exemplary DHOCNN/DHOCNN method, in accordance with an embodiment of the present invention;

FIG. 6 shows a block diagram of an exemplary basic building block Long Short-Term Memory (LSTM) 600 to which the present invention can be applied, in accordance with an embodiment of the present invention; and

FIG. 7 shows a block diagram of an exemplary basic building block Gate Recurrent Unit (GRU) 700 to which the present invention can be applied, in accordance with an embodiment of the present invention.

### DETAILED DESCRIPTION OF PREFERRED EMBODIMENTS

The present invention is directed to real-time deep learning for danger prediction using heterogeneous time-series sensor data.

In an embodiment, a real-time system is provided that uses guided deep high-order recurrent neural networks based on heterogeneous time-series sensor data.

In contrast to using a simple shallow model based on a limited number of features for danger prediction, in an embodiment, the present invention provides a driving assistance system for generating immediate alerts by integrating many sources of real-time sensor data. In an embodiment, the present invention uses a deep learning approach to analyze real-time heterogeneous time-series data generated by on-board sensors such as Global Positioning System (GPS) sensors with maps, Laser Imaging Detection and Ranging (LIDAR), driving mechanics sensors, cameras, and so forth. It is to be appreciated that the preceding types of sensors are illustrative and, thus, other types of sensors can also be used in accordance with the present invention, while maintaining the spirit of the present invention.

Unlike recent deep learning approaches to autonomous driving based on standard deep convolutional neural networks applied to a stream of static input images, the present invention provides a guided deep high-order long short-term memory for modeling the original heterogeneous time series of rich sensory input signals and also the time series of learned pattern distribution probabilities of the raw (sensory input) signals.

In an embodiment, consider a set of training time series data X. For the sake of illustration, it is presumed that all the time series have the same length. However, it is to be appreciated that the present invention can readily apply to a set of training time series data having different lengths. X is n-by-m-by-T tensor, where n is the number of training time series, m is the dimensionality of the input sensory signal vector at each time step, and T is the length of each time series. At first, clustering is performed on the training data by treating X as n times T data points with dimensionality m, through which the pattern distribution probabilities of an input signal vector at each time step is obtained for each training time series. Then, a Deep High-Order Convolutional Neural Network (DHOCNN) is used to get feature presentations of an input sensory signal vector of each time step, and we concatenate the pattern distribution vector and the feature representation vector from the DHOCNN as a new input feature vector. Time series of this new combined feature vector of input sensory signals is fed into a novel Deep High-Order Long Short-Term Memory (DHOLSTM) for danger prediction or alert category prediction. A resultant model formed by the DHOLSTM captures the high-order interactions between global pattern distribution probabilities and local feature representations generated by DHOCNN, which combines both global and local information for making better decisions. The DHOLSTM is trained by standard back-propagation. Furthermore, to prevent over-fitting and increase model robustness, we use many auxiliary tasks, for which supervision labels are easy to obtain, to pre-train the DHOCNN and the DHOLSTM and guide the parameter learning based on the curriculum learning concept. Therefore, the model formed by the present invention is interchangeably referred to as a “guided deep high-order long short-term memory”.

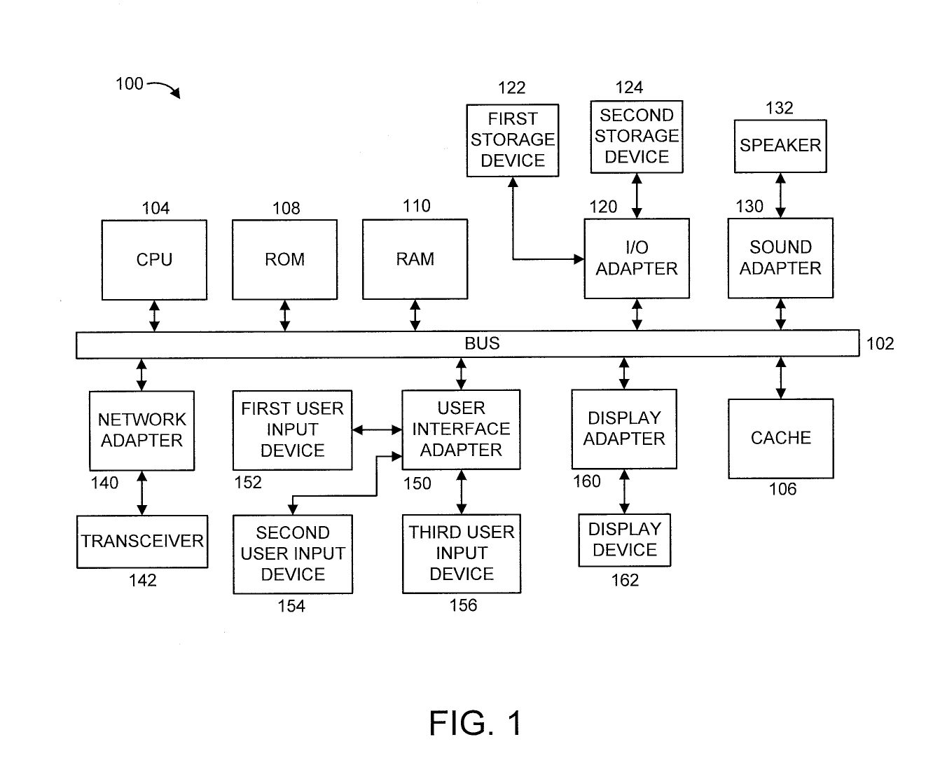

FIG. 1 shows a block diagram of an exemplary processing system 100 to which the invention principles may be applied, in accordance with an embodiment of the present invention. The processing system 100 includes at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operatively coupled to system bus 102 by the sound adapter 130. The speaker 132 can be used to provide an audible alarm or some other indication relating to resilient battery charging in accordance with the present invention. A transceiver 142 is operatively coupled to system bus 102 by network adapter 140. A display device 162 is operatively coupled to system bus 102 by display adapter 160.

A first user input device 152, a second user input device 154, and a third user input device 156 are operatively coupled to system bus 102 by user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present invention. The user input devices 152, 154, and 156 can be the same type of user input device or different types of user input devices. The user input devices 152, 154, and 156 are used to input and output information to and from system 100.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present invention provided herein.

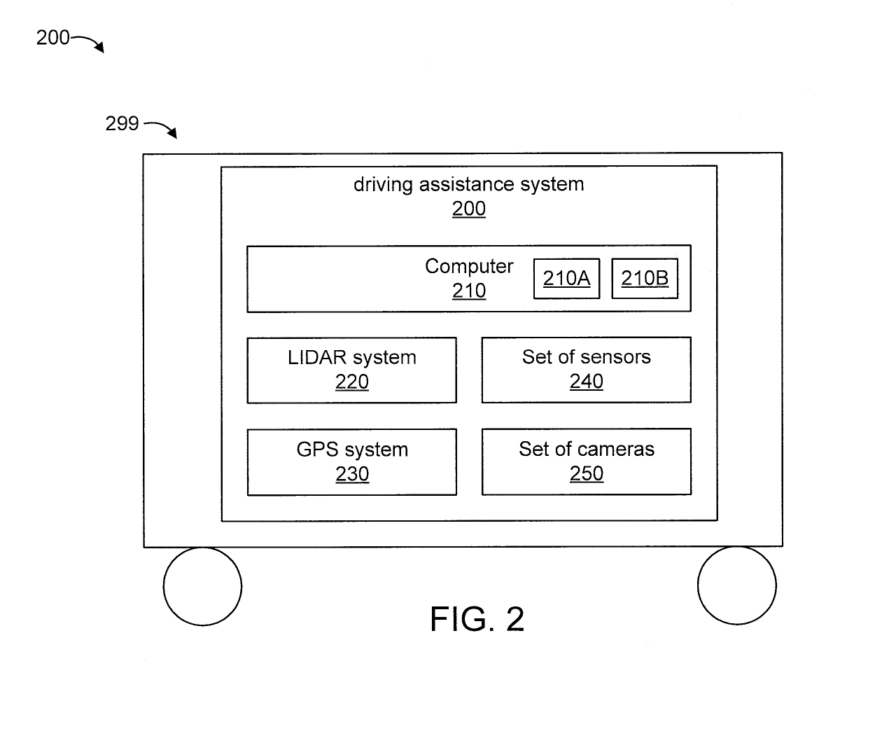

Moreover, it is to be appreciated that system 200 described below with respect to FIG. 2 is an environment for implementing respective embodiments of the present invention. Part or all of processing system 100 may be implemented in one or more of the elements of system 200.

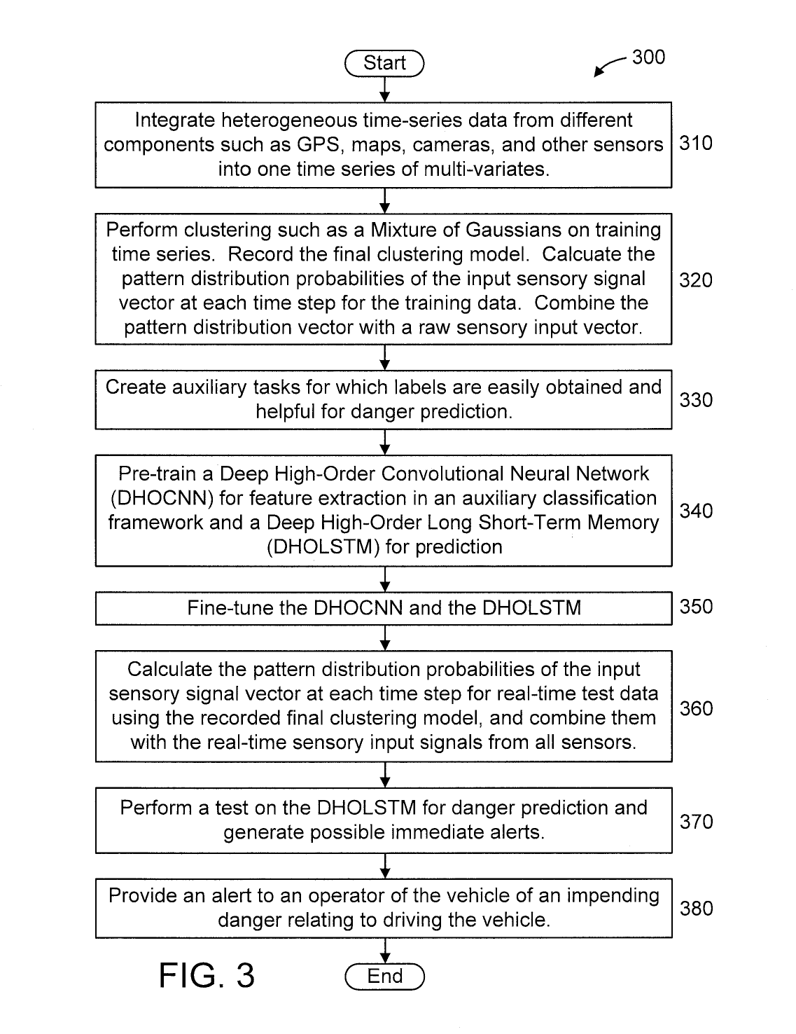

Further, it is to be appreciated that processing system 100 may perform at least part of the method described herein including, for example, at least part of method 300 of FIG. 3. Similarly, part or all of system 200 may be used to perform at least part of method 300 of FIG. 3.

FIG. 2 shows a block diagram of an exemplary driving assistance system 200, in accordance with an embodiment of the present invention. The driving assistance system 200 uses real-time deep learning for danger prediction that, in turn, uses heterogeneous time series sensor data. The driving assistance system 200 is included in a vehicle 299.

The driving assistance system 200 includes an on-board computer 210, a LIDAR system 220, a GPS system 230, a set of sensors 240, and a set of on-board cameras 250.

The on-board computer 210 includes a CPU 210A for running deep learning for danger prediction. In an embodiment, the on-board computer 210 further includes a GPU 210B for running deep learning for danger prediction.

The LIDAR system 220 generates real-time surrounding obstacle detection signals.

The GPS system 230 includes maps and generates positional and map information.

The set of sensors 240 measure vehicle related parameters such as, for example, speed, acceleration, and other real-time driving-related signals.

The set of cameras 250 capture images/video of a real-time driving environment.

FIG. 3 shows a flow diagram of an exemplary method 300 for driving assistance, in accordance with an embodiment of the present invention.

At step 310, integrate heterogeneous time-series data from different components such as GPS, maps, cameras, and other sensors into one time series of multi-variates.

At step 320, perform clustering such as a Mixture of Gaussians on training time series. Record the final clustering model. Calculate the pattern distribution probabilities of the input sensory signal vector at each time step for the training data. Combine the pattern distribution vector with a raw sensory input vector.

At step 330, create auxiliary tasks for which labels are easily obtained and helpful for danger prediction.

At step 340, pre-train a Deep High-Order Convolutional Neural Network (DHOCNN) for feature extraction in an auxiliary classification framework and a Deep High-Order Long Short-Term Memory (DHOLSTM) for prediction. That is, using additional labeled data from auxiliary tasks, we first pre-train the DHOCNN for better feature extraction, and then we pre-train the DHOLSTM. DHOCNN can be pre-trained by treating each time step of a time series as a data point without considering any temporal structure. DHOLSTM can be pre-trained on time series by considering temporal structures.

At step 350, fine-tune the DHOCNN and the DHOLSTM.

At step 360, calculate the pattern distribution probabilities of the input sensory signal vector at each time step for real-time test data using the recorded final clustering model, and combine them with the real-time sensory input signals from all sensors.

At step 370, perform a test on the DHOLSTM for danger prediction and generate possible immediate alerts.

At step 380, provide an alert to an operator of the vehicle of an impending danger relating to driving the vehicle.

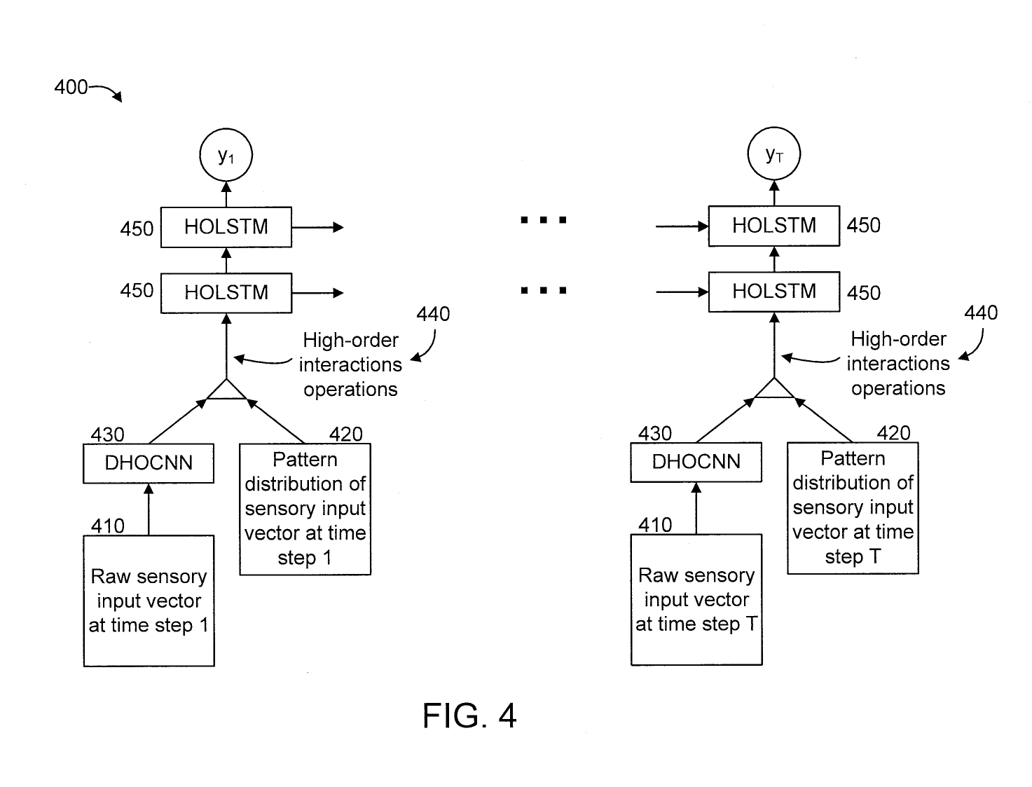

FIG. 4 shows a block diagram of an exemplary Deep High-Order Long Short-Term Memory (DHOLSTM) 400, in accordance with an embodiment of the present invention.

The DHOLSTM 400 includes, for each time step from time step t₁ to time step t_{T}, a raw sensory input (at that time step) 410, pattern distribution probabilities of the sensory input vector (at that time step) 420, a DHOCNN (for receiving the raw sensory input at that time step) 430, high-order interaction operations 440, and multiple High-Order Long Short-Term Memories (HOLSTMs) 450 that generate a respective prediction y (y₁ through y_{T}).

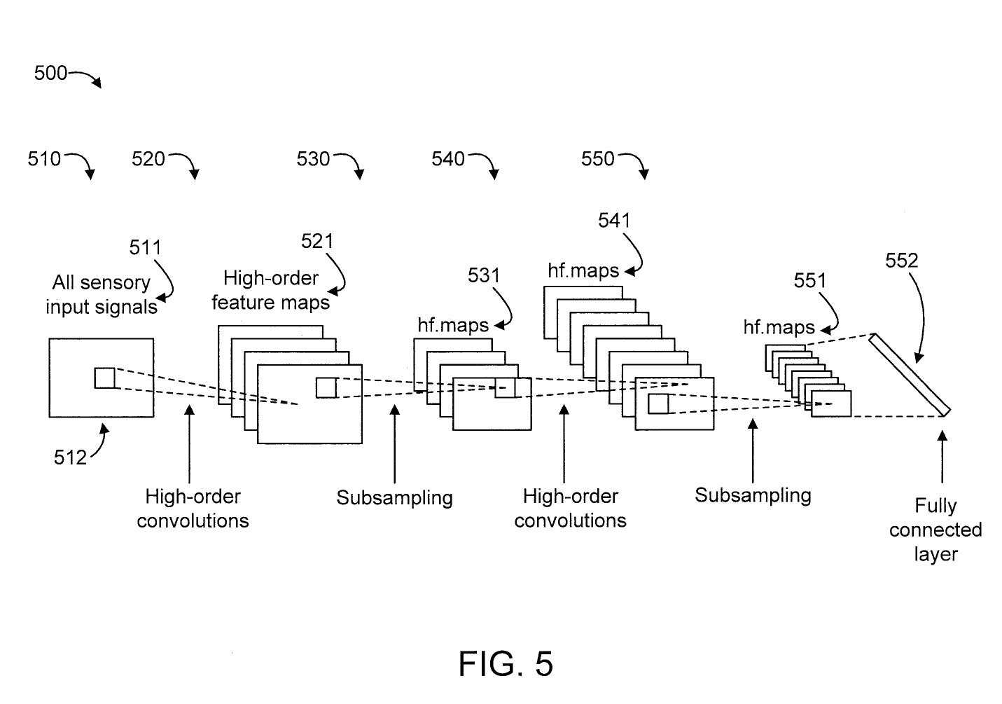

FIG. 5 shows a block/flow diagram of an exemplary DHOCNN/DHOCNN method 500, in accordance with an embodiment of the present invention.

At step 510, receive all sensory input signals 511 and an input image 512.

At step 520, perform high-order convolutions on the sensory input signals 511 and the input image 512 to obtain high-order feature maps 521.

At step 530, perform sub-sampling on the high-order feature maps 521 to obtain a set of hf.maps 531.

At step 540, perform high-order convolutions on the set of hf.maps 531 to obtain another set of hf.maps 541.

At step 550, perform sub-sampling on the other set of hf.maps 541 to obtain yet another set of hf.maps 551 that form a fully connected layer 552. The fully connected layer 552 includes a feature vector.

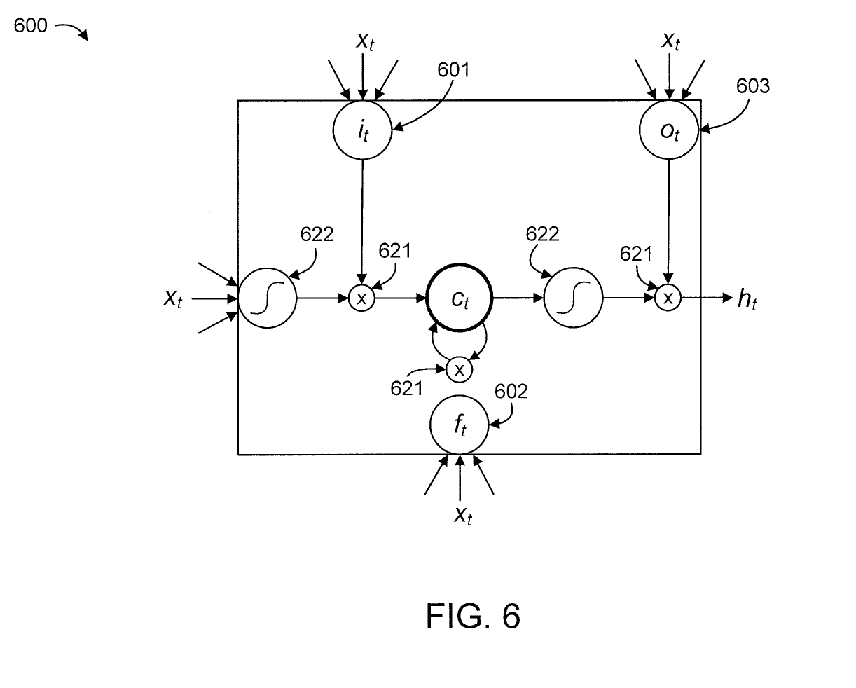

FIG. 6 shows a block diagram of an exemplary basic building block Long Short-Term Memory (LSTM) 600 to which the present invention can be applied, in accordance with an embodiment of the present invention.

The basic building block LSTM 600 includes an input gate it 601, a forget gate ft 602, and an output gate ot 603. The basic building block LSTM 600 further includes multipliers 621, and a sigmoid function unit 622.

The equations for the 3 gates are as follows:

iₜ=σ(wₓᵢxₜ+wₕᵢhₜ₋₁+bᵢ)

fₜ=σ(wₓⱼxₜ+wₕⱼhₜ₋₁+b_{f})

oₜ=σ(wₓₒxₜ+wₕₒhₜ₋₁+bₒ)

Correspondingly, the update equations are as follows:

cₜ=fₜ⊙cₜ₋₁+iₜ⊙ tan h(w_{xc}xₜ+w_{hc}hₜ₋₁+b_{c})

hₜ=oₜ⊙ tan h(cₜ)

where ⊙ is element-wise multiplication.

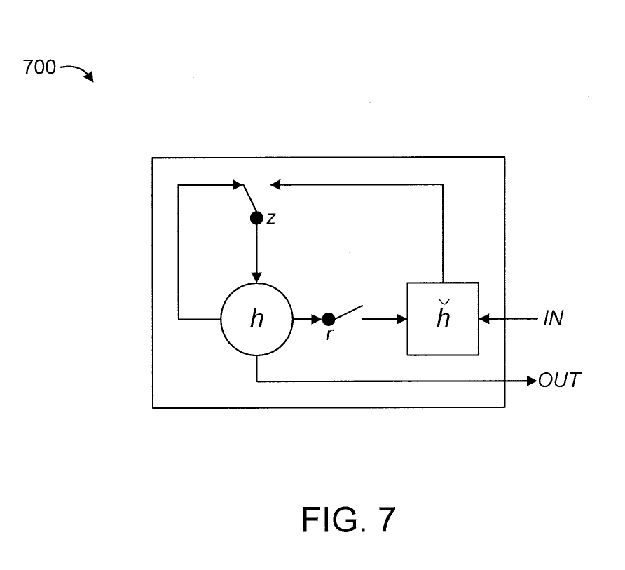

FIG. 7 shows a block diagram of an exemplary basic building block Gate Recurrent Unit (GRU) 700 to which the present invention can be applied, in accordance with an embodiment of the present invention. In FIG. 7, z denotes an update gate vector, r denotes a reset gate vector, h denotes an output vector, \check{h} denotes candidate activation, IN denotes the input to the GRU 700, and OUT denotes the output from the GRU 700.

The GRU 700 can performs comparable or better than a LSTM.

The update equations are as follows:

zₜ=σ(w_{xz}xₜ+w_{hz}hₜ₋₁+b_{z})

rₜ=σ(wₓᵣxₜ+wₕᵣhₜ₋₁+bᵣ)

\check{h}ₜ=tan h(wₓₕxₜ+wₕₕ(rₜ⊙hₜ₋₁)+bₕ)

hₜ=zₜ⊙hₜ₋₁+(1−zₜ)⊙\check{h}ₜ

In LSTM and GRU, the gate functions at time t are all sigmoid functions over a linear combination of current input xₜ and the memory represented via hₜ₋₁. While gating functions are crucial for the network's performance, we further introduce a high order gating function as follows:

gₜ=σ(wₓxₜ+wₕhₜ₋₁+b_{g}+f(xₜ,hₜ₋₁))

where all vectors have dimension n. Here we only consider second order information. Assuming we are using m high order kernels, then we have the following:

$$f ( {x}_{t} , {h}_{t} - 1 ) = P ( \begin{matrix}{x}_{t}^{T} {w}_{xh}^{( 1 )} {h}_{t - 1} \\ {x}_{t}^{T} {w}_{xh}^{( 2 )} {h}_{t - 1} \\ ⋮ \\ {x}_{t}^{T} {w}_{xh}^{( m )} {h}_{t - 1}\end{matrix} ) , P ∈ {nxm}^{}$$

where P is a mapping from m kernel output to a vector of dimension n as required.

If we use low rank approximation, i.e., wₓₕ⁽ⁱ⁾=Σⱼ₌₁^{r}(vⱼ⁽ⁱ⁾)(uⱼ⁽ⁱ⁾)^{T}, we can rewrite each element in the high order term to be as follows:

xₜ^{T}wₓₕ⁽ⁱ⁾hₜ₋₁Σⱼ₌₁^{r}(vⱼ⁽ⁱ⁾)^{T}xₜ·(uⱼ⁽ⁱ⁾)^{T}hₜ₋₁

As we are learning distributed feature representation, it's reasonable to use vⱼ⁽ⁱ⁾ same uⱼ⁽ⁱ⁾ in order to reduce the number of parameters, i.e., high order kernel weight matrices wₓₕ⁽ⁱ⁾ are all symmetric. Thus we have the following:

xₜ^{T}wₓₕ⁽ⁱ⁾hₜ₋₁=<Vxₜ,Vhₜ₋₁>,Vε [symbol] ^{rxn}

For each gating function, the number of parameters we introduced is n*m+r*n*m, in addition to linear part 2*n*n+n.

Alternatively, the high order term can be as follows:

f(xₜ,hₜ₋₁)=W(Uₓₜ⊙Vhₜ₋₁)

where ⊙ represents for element-wise multiplication, and U,Vεr [symbol] ^{m×n}, Wε [symbol] ^{n×m}. The corresponding total number of parameters for each gating function is n*m+2*n*m in addition to linear 2*n*n+n. The difference between Equation 3 and Equation 1, besides using different U and V, is that Equation 3 only uses one high kernel term whereas Equation 1 uses m high order terms. However, Equation 1 is not a general case for Equation 3.

Also, we can have a multiple layer perceptron for modeling the transition between hidden states.

As shown in Equation 2, the high order term can be represented as a concatenation of a fully connected layer and a dot-product layer. Thus learning could also be done via standard back-propagation.

A description will now be given regarding specific competitive/commercial advantages of the solution achieved by the present invention.

One advantage is that the proposed driving assistance system is universal and can be widely used to build many types of smart vehicles or even autonomous vehicles.

Another advantage is that the proposed driving assistance system has a much lower cost than an autonomous driving system.

Yet another advantage is that the proposed system is much more accurate and robust than previous driving assistance systems.

Still another advantage is that the proposed system can be easily adapted and deployed for traffic surveillance and manufacturing monitoring.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening L/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for providing driver assistance for a vehicle, comprising:
forming, by a processor, a deep High-Order Long Short-Term Memory (HOLSTM)-based model by applying, to a HOLSTM, high-order interactions captured between global pattern distribution probabilities and local feature representations of an input sensor signal vector at each of a plurality of time steps, the input sensor signal vector formed from multiple time series, each of the multiple time series corresponding to a different one of a plurality of driving related sensors;
generating, by the processor, one or more predictions of impending dangerous conditions related to driving the vehicle based on the deep HOLSTM-based model; and
informing, by an operator-perceptable warning device, an operator of the vehicle of the one or more predictions of impending dangerous conditions.

2. The computer-implemented method of claim 1, wherein the global pattern distribution probabilities are obtained by clustering the multiple time series.

3. The computer-implemented method of claim 1, wherein the local feature representations are obtained by applying a Deep High-Order Convolutional Neural Network (DHOCNN) to the input sensor signal vector at each of the plurality of time steps.

4. The computer-implemented method of claim 1, further comprising concatenating (i) a feature representation vector generated by a Deep High-Order Convolutional Neural Network (DHOCNN) and (ii) a pattern distribution vector, to form a new input feature vector, the new feature vector being comprised in the local feature representations.

5. The computer-implemented method of claim 1, wherein the multiple time series form a training data set consisting of an n-by-m-by-T tensor, where n is a number of training time series in the training data set, m is a dimensionality of the input sensor signal vector at each time step, and T is a length of each of the multiple time series.

6. The computer-implemented method of claim 5, further comprising clustering the training data set by treating the training data set as n times T data points with dimensionality m, through which the global pattern distribution probabilities of the input signal vector at each of the plurality of time steps is obtained for each of the multiple time series.

7. The computer-implemented method of claim 1, further comprising pre-training the deep HOLSTM-based model and a High-Order Convolution Neural Network (HOCNN)-based feature extraction model using a plurality of auxiliary tasks relating to potential dangerous conditions which generate supervision labels and guide parameter learning for the deep HOLSTM-based model.

8. The computer-implemented method of claim 1, further comprising integrating the multiple time series into a single time series of multi-variates from which the input sensor signal vector is obtained.

9. A computer program product for providing driver assistance for a vehicle, the computer program product comprising a non-transitory computer readable storage medium having program instructions embodied therewith, the program instructions executable by a computer to cause the computer to perform a method comprising:
forming, by a processor, a deep High-Order Long Short-Term Memory (HOLSTM)-based model by applying, to a HOLSTM, high-order interactions captured between global pattern distribution probabilities and local feature representations of an input sensor signal vector at each of a plurality of time steps, the input sensor signal vector formed from multiple time series, each of the multiple time series corresponding to a different one of a plurality of driving related sensors;
generating, by the processor, one or more predictions of impending dangerous conditions related to driving the vehicle based on the deep HOLSTM-based model; and
informing, by an operator-perceptable warning device, an operator of the vehicle of the one or more predictions of impending dangerous conditions.

10. The computer program product of claim 9, wherein the global pattern distribution probabilities are obtained by clustering the multiple time series.

11. The computer program product of claim 9, wherein the local feature representations are obtained by applying a Deep High-Order Convolutional Neural Network (DHOCNN) to the input sensor signal vector at each of the plurality of time steps.

12. The computer program product of claim 9, wherein the method further comprises concatenating (i) a feature representation vector generated by a Deep High-Order Convolutional Neural Network (DHOCNN) and (ii) a pattern distribution vector, to form a new input feature vector, the new feature vector being comprised in the local feature representations.

13. The computer program product of claim 9, wherein the multiple time series form a training data set consisting of an n-by-m-by-T tensor, where n is a number of training time series in the training data set, m is a dimensionality of the input sensor signal vector at each time step, and T is a length of each of the multiple time series.

14. The computer program product of claim 13, wherein the method further comprises clustering the training data set by treating the training data set as n times T data points with dimensionality m, through which the global pattern distribution probabilities of the input signal vector at each of the plurality of time steps is obtained for each of the multiple time series.

15. The computer program product of claim 9, wherein the method further comprises pre-training the deep HOLSTM-based model and a High-Order Convolution Neural Network (HOCNN)-based feature extraction model using a plurality of auxiliary tasks relating to potential dangerous conditions which generate supervision labels and guide parameter learning for the deep HOLSTM-based model.

16. The computer program product of claim 9, wherein the method further comprises integrating the multiple time series into a single time series of multi-variates from which the input sensor signal vector is obtained.

17. A system for providing driver assistance for a vehicle, comprising:
a processor, configured to:
form a deep High-Order Long Short-Term Memory (HOLSTM)-based model by applying, to a HOLSTM, high-order interactions captured between global pattern distribution probabilities and local feature representations of an input sensor signal vector at each of a plurality of time steps, the input sensor signal vector formed from multiple time series, each of the multiple time series corresponding to a different one of a plurality of driving related sensors; and
generate one or more predictions of impending dangerous conditions related to driving the vehicle based on the deep HOLSTM-based model; and
an operator-perceptable warning device configured to inform an operator of the vehicle of the one or more predictions of impending dangerous conditions.

18. The system of claim 17, wherein the processor is further configured to concatenate (i) a feature representation vector generated by a Deep High-Order Convolutional Neural Network (DHOCNN) and (ii) a pattern distribution vector, to form a new input feature vector, the new feature vector being comprised in the local feature representations.

19. The system of claim 17, wherein the multiple time series form a training data set consisting of an n-by-m-by-T tensor, where n is a number of training time series in the training data set, m is a dimensionality of the input sensor signal vector at each time step, and T is a length of each of the multiple time series.

20. The system of claim 19, wherein the processor is further configured to cluster the training data set by treating the training data set as n times T data points with dimensionality m, through which the global pattern distribution probabilities of the input signal vector at each of the plurality of time steps is obtained for each of the multiple time series.
